(19) United States
(12) Patent Application Publication
(10) Pub. No.: US 2026/0057410 A1
(43) Pub. Date: Feb. 26, 2026

(54) IDENTIFYING CLICK QUALITY AS AN AD PERFORMANCE METRIC

(71) Applicant: Snap Inc., Santa Monica, CA (US)

(72) Inventors: Christopher Mark Glass DiFeliciantonio, Los Angeles, CA (US); Ian Schultz, Thousand Oaks, CA (US)

(21) Appl. No.: 19/304,086

(22) Filed: Aug. 19, 2025

Related U.S. Application Data
(60) Provisional application No. 63/685,107, filed on Aug. 20, 2024.

(51) Int. Cl. G06Q 30/0242; G06F 11/34

(52) U.S. Cl. CPC G06Q 30/0246; G06F 11/3438

(57) ABSTRACT

Described is a system for inferring ad quality by accessing user interaction data of users on an application and corresponding conversion data, the user interaction data including click behavior of the plurality of users; processing the user interaction data and the conversion data via a machine learning model to train the machine learning model, the machine learning model being trained to infer a conversion probability based on new user interaction data; displaying an impression on a user interface of the application to a first user; determining that the first user has selected the displayed impression; accessing first user interaction data of a first user indicative of first user click behavior; processing the first user interaction data via the machine learning model to generate a conversion probability; and determining whether the selection of the first user of the displayed impression is a low-quality click based on the conversion probability.

### CLAIM OF PRIORITY

This application claims the benefit of priority to U.S. Provisional Application Ser. No. 63/685,107, filed Aug. 20, 2024, which is incorporated herein by reference in its entirety.

### TECHNICAL FIELD

The present disclosure relates generally to ad performance metrics, and more specifically to identifying click quality as an ad performance metric.

### BACKGROUND

As the popularity of online mobile applications grows, companies use data analysis techniques to provide recommended content to users, such as through impressions of advertisements. Platforms identify ad metrics to determine which ads are more relevant for a particular user. These recommendations aim to keep users engaged with the platform by showing them ads that are relevant and interesting to them. Based on the collected data of the user, companies create a user profile that is used to identify relevant content on their platforms.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an example method 400 for determining a click quality, according to some examples.

FIG. 5 illustrates an architectural diagram for training and applying a machine learning model that is trained to infer ad click quality, according to some examples.

FIG. 6 illustrates a machine learning model that can infer ad quality regardless of ad characteristics, according to some examples.

FIG. 7 is a diagrammatic representation of a message, according to some examples.

FIG. 8 illustrates a system including a head-wearable apparatus with a selector input device, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

FIG. 11 illustrates a machine-learning pipeline, according to some examples.

FIG. 12 illustrates training and use of a machine-learning program, according to some examples.

### DETAILED DESCRIPTION

Traditional ad quality assessment systems often rely on rule-based approaches. These systems use predefined rules and thresholds to determine the quality of an ad interaction. For example, a rule might be that any ad click with a viewing time of less than 5 seconds is considered low quality.

Such rule-based systems are inflexible and cannot adapt to changing user behaviors or new types of ads. They require constant updates and manual adjustments to remain effective. Moreover, these systems typically focus on a narrow set of metrics and fail to capture the complexity of user interactions. They cannot account for nuanced behaviors that may indicate high or low-quality clicks. The rigid nature of rules often leads to inaccurate assessments, either by misclassifying genuine interest as low quality or overlooking subtle indicators of poor engagement.

Another significant limitation of traditional rule-based systems is their inability to adapt effectively to all situations, particularly when data visibility is restricted due to technical constraints or user privacy concerns. Rule-based systems rely on predefined, static rules that are often designed with full data access in mind. However, in real-world scenarios, data visibility can be inconsistent, and access to certain types of user data may be limited or entirely unavailable, such as due to privacy regulations like GDPR or CCPA. This inflexibility means that rule-based systems can fail to make accurate predictions when the data they rely on is incomplete or obscured, leading to suboptimal ad performance and missed opportunities in dynamic environments.

Some traditional systems employ basic statistical models to analyze user interactions. These models might use averages, medians, or other simple statistical measures to gauge ad performance. However, these statistical models often oversimplify the data, missing out on complex patterns and relationships between different user behaviors and ad interactions.

These models typically perform static analysis without incorporating real-time data, making them less responsive to immediate changes in user behavior or ad performance. Such models lack the sophistication to accurately predict conversion probabilities or click quality, resulting in suboptimal ad targeting and performance assessments.

Some traditional systems use heuristic-based systems via a set of heuristics or experience-based techniques to evaluate ad quality. These heuristics are often derived from historical data and expert insights.

Heuristic methods can be heavily biased by the experiences and assumptions of those who develop them. This subjectivity can lead to inconsistent and unreliable evaluations. Moreover, as the volume and variety of ad interactions increase, heuristic-based systems struggle to scale effectively. They are not well-suited to handle the complexity of modern ad ecosystems. Heuristics are likely to fail to generalize across different types of ads, user behaviors, and contexts, leading to limited applicability.

Traditional ad quality assessment systems are hindered by inflexibility, oversimplification, bias, scalability issues, and the labor-intensive nature of manual review. These deficiencies limit their effectiveness in accurately evaluating and predicting ad quality, especially in dynamic and complex digital advertising environments.

In some cases, the interaction system mitigates or eliminates the deficiencies of the traditional systems described above. The interaction system utilizes machine learning models to assess ad quality, making it highly flexible and adaptable to changing user behaviors and new types of ads.

Moreover, unlike rule-based systems, the machine learning models continuously learn and adapt from new data. This dynamic learning process allows the interaction system to stay current with evolving user interactions and ad formats without requiring constant manual updates.

The interaction system can analyze a broad range of user interaction metrics, capturing the complexity of behaviors that indicate ad click quality. This comprehensive analysis leads to more accurate and nuanced assessments. The machine learning model processes extensive user interaction data to generate precise conversion probabilities, overcoming the limitations of basic statistical models.

By using advanced algorithms, the interaction system can identify complex patterns and relationships within the data. This sophistication results in more accurate predictions of ad click quality and conversion probabilities. Moreover, the interaction system can incorporate real-time data into its analysis, allowing for immediate adjustments and optimizations based on current user interactions.

The machine learning model provides objective and consistent evaluations of ad quality, addressing the biases and subjectivity inherent in heuristic-based approaches. Furthermore, the machine learning approach scales effectively with increasing data volumes and diverse ad interactions, maintaining high performance and reliability.

The interaction system leverages a wide range of user interaction data to train the machine learning model, including click behavior, view times, swipe angles, and more. By analyzing detailed user interaction metrics, the interaction system gains a deep understanding of user behavior, leading to more accurate predictions of click quality and conversion probabilities. The interaction system can evaluate user interactions across different platforms (e.g., mobile, PC) and ad formats, ensuring consistent performance and applicability in various contexts.

The interaction system addresses the deficiencies of traditional systems by leveraging machine learning to provide flexible, accurate, and consistent ad quality assessments. The interaction system automates the evaluation process, incorporates near-real-time data, and analyzes a comprehensive set of user interaction metrics, resulting in a highly effective and efficient solution for predicting ad quality and conversion probabilities.

The interaction system uses machine learning (ML) methods, which are inherently more adaptable and robust compared to rule-based systems. Instead of relying on fixed rules that require complete data visibility, the ML-based approach can learn from the data that is available, even when it is partial or constrained by privacy requirements. By training models on diverse datasets, including those with limited visibility, the system learns to make accurate predictions by identifying patterns and correlations that go beyond simple rule application. This adaptability ensures that the system remains effective in a wide range of scenarios, providing accurate ad ranking and conversion predictions even when data access is limited or governed by strict privacy controls. Through the use of ML, the interaction system is better equipped to handle real-world constraints, maintaining high performance and reliability regardless of data availability.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in an ad click quality determination process. Computing resources used by one or more machines, databases, or networks may thus be more efficiently utilized or even reduced.

### NETWORKED COMPUTING ENVIRONMENT

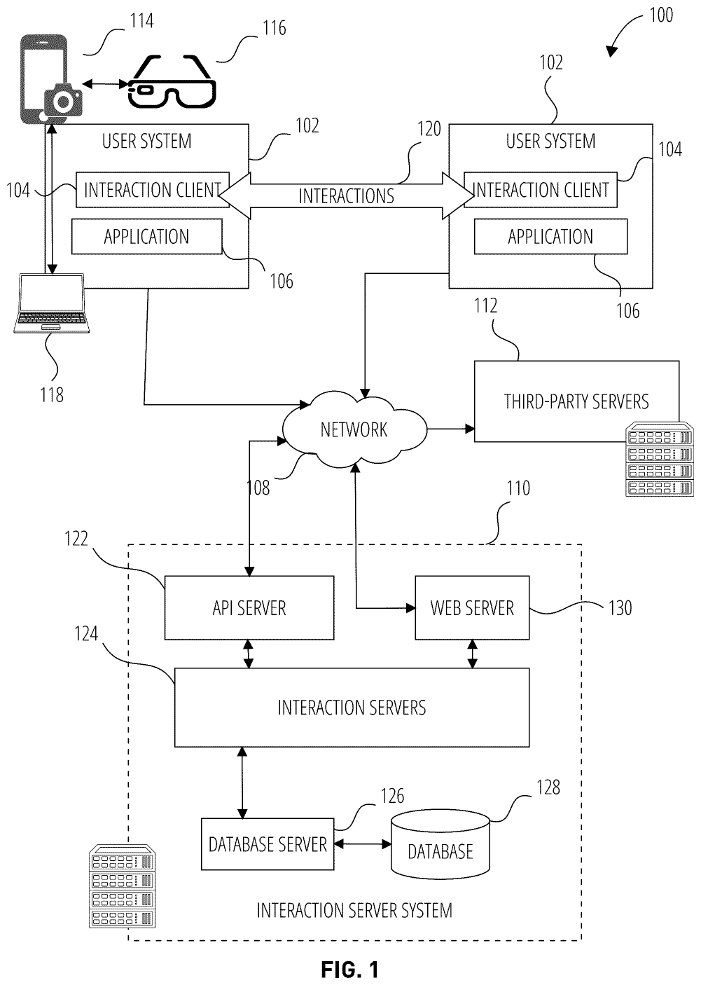

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

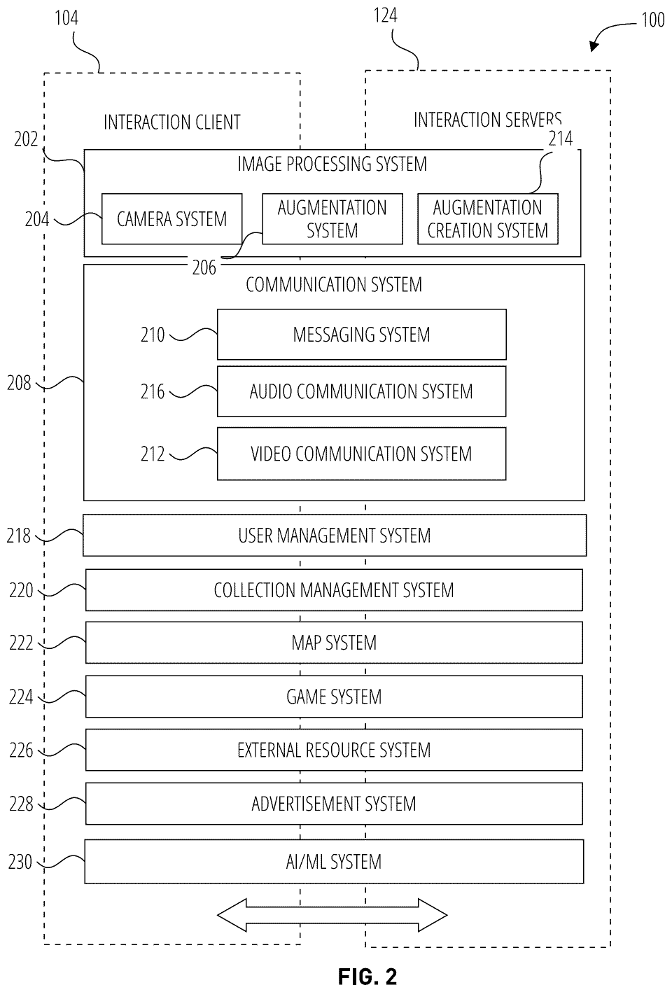

The interaction servers 124 hosts multiple systems and subsystems, described below with reference to FIG. 2.

### LINKED APPLICATIONS

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### SYSTEM ARCHITECTURE

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 802 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### DATA ARCHITECTURE

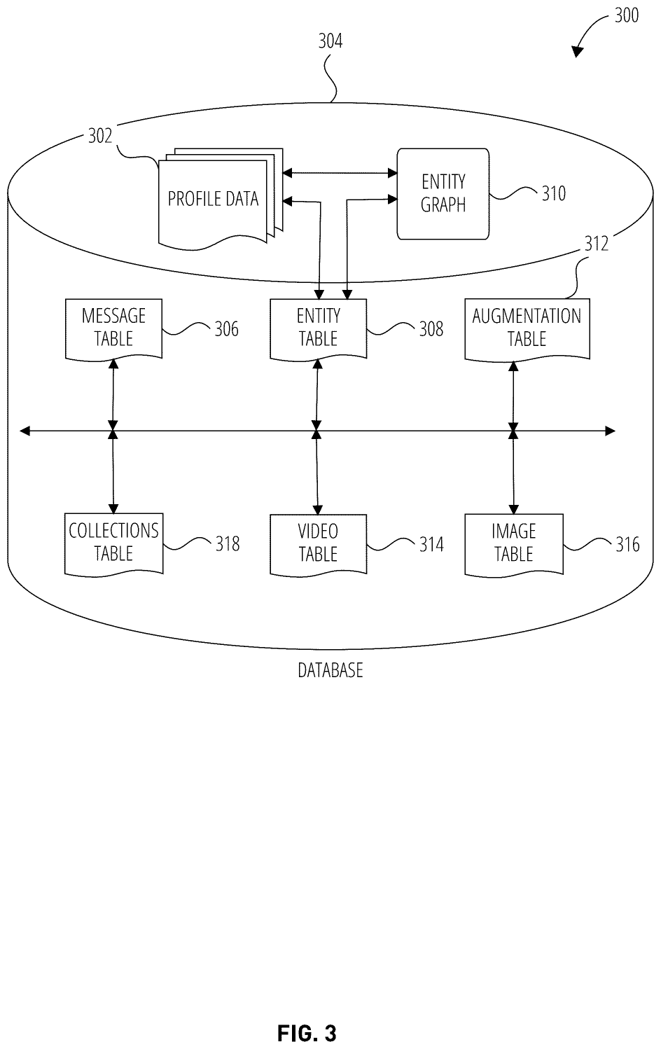

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### DETERMINING CLICK QUALITY

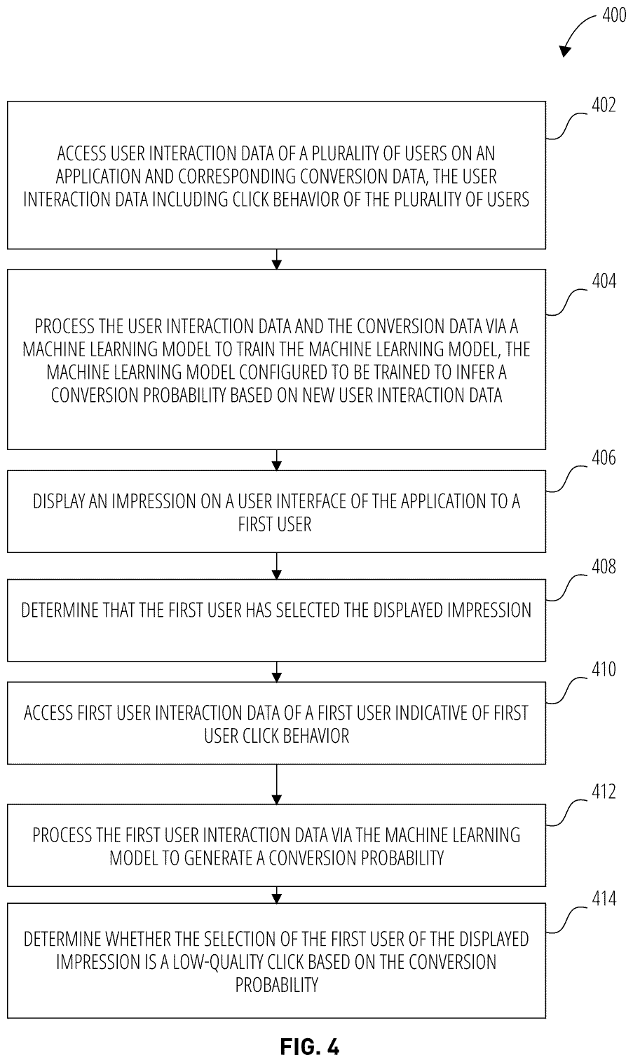

FIG. 4 illustrates an example method 400 for determining a click quality, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

FIG. 4 is described as being performed by certain systems or applying certain processes, such as a particular machine learning model, but the processes described herein can be performed by one or more other machine learning models, or a combination thereof.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

At block 402, the interaction client accesses user interaction data of a plurality of users on an application and corresponding conversion data, the user interaction data including click behavior of the plurality of users. This data forms the backbone of the supervised machine learning model used to identify click quality, such as low-quality ad clicks.

The user interaction data can encompass a wide range of activities that users engage in within the application, such as their click behavior. Click behavior includes various metrics such as a number of clicks on ads, the types of ads clicked, the frequency of clicks, the time spent between clicks, the sequence of user actions leading to and following the clicks, and/or the like (as described further herein). The user interaction data provides insights into how users interact with the ads and other elements within the application.

Although examples of user interaction data are explained for a particular feature (such as for training the machine learning model), any subset of the user interaction data can be applied for the feature (such as for training the machine learning model) and/or any subset of the user interaction data can be applied for another feature described herein (such as during inference).

The conversion data is also important as this data indicates whether the user's interaction with the ad led to a desired outcome or conversion. A conversion can include a variety of different outcomes, such as depending on the campaign's goals. A conversion can include completing a purchase, signing up for a newsletter, downloading an app, or any other action that signifies user engagement leading to a successful outcome.

By correlating the interaction data with conversion data, the model can discern patterns and characteristics typical of certain quality clicks (such as high quality clicks that are likely to result in conversions), and distinguish them from other types of clicks (such as low-quality clicks).

In some cases, there is a subset of user interaction data only available to the interaction system for certain ads. For example, an ad can route the user to an internal interaction function on the interaction system. The internal interaction function can include an internal browser or other feature.

In some examples, interaction functions include user interaction with a camera feed displayed on the user system 102, such as selecting a real-world object on a camera feed or selecting a digital item or overlay shown on the camera feed. In some examples, interaction functions also include a chat window where messages, stickers, emojis, and other media content items are shared between users via user systems 102.

Interaction functions further include sending photos or videos to friends, either individually or in groups, which are edited with text, stickers, filters, and drawings before being sent. Interaction functions include capturing a video or audio, inputting text, or other communications that disappear after certain conditions are met, such as being viewed once or setting a time limit, creating a more ephemeral and casual sharing experience.

In some examples, interaction functions include generating or viewing a collection of videos, messages, stickers, or other media content items that are visible to friends for a certain period of hours (e.g., 24 hours). Interaction functions include displaying media content items from other users, such as publishers, creators, and influencers, where users explore and subscribe to different channels to receive updates on their favorite content. Interaction functions include map and location functions, such as users sharing their location with friends and viewing their friends'locations on a map, or exploring a map with points of interest by other users categorized by location and events.

In some examples, interaction functions include generating or applying various filters and content augmentations to enhance images, videos, or other media content items to share with others, such as by adjusting the color or appearance or adding interactive elements such as animations and facial transformations, in real-time. Interaction functions include saving favorite media content items with other users in a private archive, where users access these saved media content items later, edit them, or share them with friends.

Interaction functions include personalizing or applying avatars which are used as a profile picture to be viewed by others and in stickers, chat, and image/video decorations.

Interaction functions include playing multiplayer games that users play with their friends directly within the user interface of the system to share messages and media content items.

Interaction functions include capturing data by an Augmented Reality (AR) device. In some examples, the interaction system 100 captures motion and position data, such as data from accelerometers, gyroscopes, and magnetometers to track user movement or orientation. In some examples, the interaction system 100 captures eye-tracking data which monitors the user's eye movements and focus, gaze-based interactions, objects the user is focused (or not focused) on, or user attention patterns.

In some cases, there is a subset of user interaction data only available to certain users that opt-in to providing the interaction system with user interaction data, such as user interaction data available from third parties. Such data can include how far down a user scrolls on the third party landing page, indicating engagement with the content, the total time a user spends on the landing page, the sequence of clicks and navigation paths within the landing page, and interactions with forms on the landing page, such as input field focus, keystrokes, and form submissions.

Such data can also include how users interact with multimedia content like videos, images, or interactive elements (e.g., clicks on play/pause, adjusting volume, or viewing full-screen) on the landing page, mouse hover data on the landing page that indicates which elements users are considering interacting with, or specific actions that qualify as conversions on the landing page, such as completing a purchase, signing up for a newsletter, or downloading a resource. Such data can also include patterns in user behavior on the landing page, such as repeated visits to certain sections, frequency of interactions, and changes in interaction behavior over time.

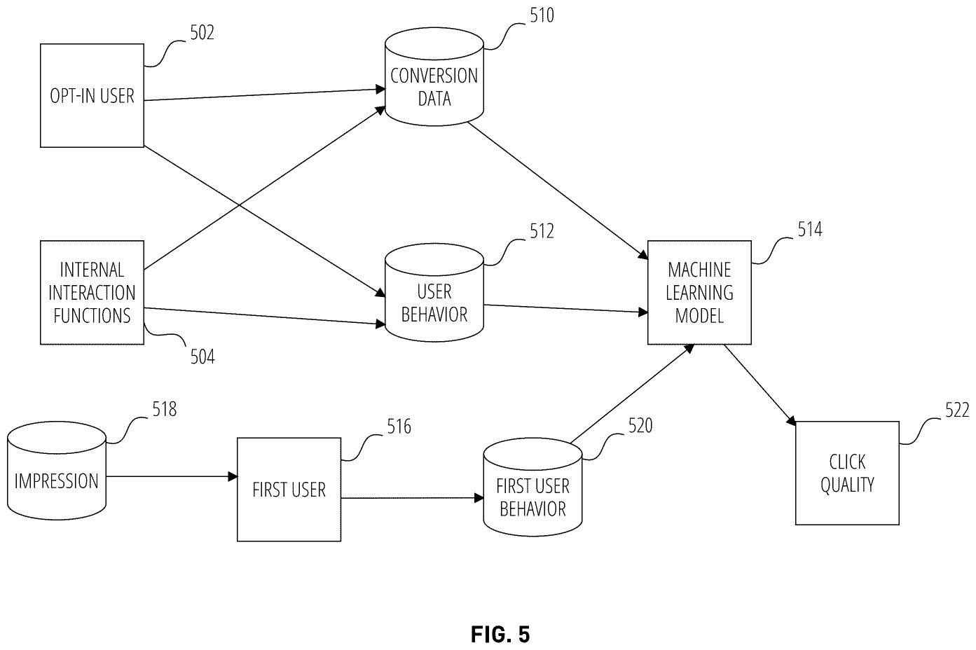

FIG. 5 illustrates an architectural diagram for training and applying a machine learning model that is trained to infer ad click quality, according to some examples. The interaction system can gather user interaction data where the ad sends the users to internal interaction functions 504. The interaction system can gather user behavior data 512 and can apply such user interaction data to a machine learning model 514 to train the user machine learning model on user behavior subsequent to a user clicking on the ad. Moreover, the interaction system can gather conversion data 510 within these internal interaction functions and apply such data to the machine learning model for training.

In some cases, such data can be retrieved from opt-in users via UTM parameters that are appended to URLs and help track the source of traffic when users arrive at the third-party site. The third-party site can then provide aggregated data back to the original application. Such data can be obtained via tracking pixels that include small, invisible images included in emails or web pages that can track user behavior when loaded, or API integrations where the third-party site shares interaction data back with the original application through API calls, although this requires cooperation between the platforms.

In some cases, such data can include a click to dismiss metric that measures the duration for which a user views the third party landing page after clicking on an advertisement. The third party can count the moment the user clicks the ad and the landing page appears or a time when the user is received by the third party, and the timer continues until the user actively dismisses it, either by clicking to close or by navigating away. This data provides insights into user engagement with the ad content, where longer viewing times may indicate higher interest or engagement, while shorter times suggest that the content failed to capture the user's attention effectively.

As described in the some embodiments herein, during inference, the machine learning model may not have such data on a first user and may only have visibility to user behavior data on the interaction platform. As such, the machine learning model can infer ad click quality based on training data where the machine learning model has such user interaction data on third party platforms as well as conversion data. Moreover, the model is adaptive in the sense that the model learns which data to rely on in the absence of other training features. When certain features are missing or unavailable, the model dynamically adjusts its learning process to prioritize the most relevant and available data, ensuring that predictions remain accurate and reliable even in scenarios with incomplete data.

As shown in FIG. 5, the interaction system can also gather data from opt-in users 502 who have opted into providing such data to the interaction system. The interaction system can also gather user behavior data 512 and/or conversion data 510 and apply such data to a machine learning model 514 for training.

In some cases, the interaction system gathers user interaction data that is available for both training of the machine learning model and for inference. User behavior data prior to the clicking of the ad, or visible data subsequent to the clicking of the ad can be available for both training and inference.

In some cases, the interaction system gathers a time metric that can indicate a user's interest or engagement with an ad. In some cases, the interaction system gathers a return to app (RTA) time metric that tracks the duration between a user leaving the app to engage with external content (such as an ad opened in an external browser) and the user's subsequent return to the app. This metric can be specifically categorized for different platforms, such as RTA time for an external browser and or RTA time for an external app.

The RTA time metric helps determine the quality of the interaction. For example, if the user returns to the app within a shorter timeframe (below a certain threshold), the machine learning model can consider this a factor of a low-quality interaction because the user quickly abandoned the external content, suggesting a lack of genuine interest or engagement. Conversely, longer return times might indicate more in-depth interaction with the external content.

In some cases, the interaction system gathers a view time metric that measures how long a user views the advertisement when it first appears. This metric can help the machine learning model understand the initial engagement with the ad. The duration of this view can indicate the level of interest or attention the ad captures immediately. A longer view time suggests that the ad is compelling and engaging, holding the user's attention, while a shorter view time may indicate that the ad fails to capture interest effectively.

In some cases, the interaction system gathers other forms of time-related metrics, such as a total time a user spends in a single session on the app, time taken for a user to interact with an ad after it appears, time gap between successive user interactions within a session, duration for which an ad is visible to the user before any interaction, time spent on a specific page or feature within the app, time spent hovering over an interactive element without clicking, time spent viewing content or an ad before navigating away, total time engaged with interactive elements (e.g., clicking, swiping, tapping) of the impression, time taken for the app to respond after a user action, or time taken for an ad to load and become visible to the user.

In some cases, the interaction system gathers an interaction intensity metric that quantifies how intensely a user interacts with features such as ads, buttons, the app, or other interactive components. Such a metric includes various aspects such as the speed and force of user interactions (e.g., swipes), the duration and pressure of taps, the frequency of interactions within a given time frame, and the overall responsiveness of the user.

In some cases, the interaction system gathers a swipe angle metric which captures the angle at which a user interacts with the application using a finger (such as swipes their thumb while interacting with an app), which can reflect the way they engage with the interface. This metric, along with the distance and speed of the swipe, can provide detailed insights into user behavior including the certainty of intentions motivating the interaction.

For instance, different swipe angles can trigger various actions, such as swiping left to view another post or swiping right to access a different feature. Understanding the nuances of swipe angles can be useful for the machine learning model because the angles can help to determine whether the swipe was accidental (e.g., if the angle of a swipe is too close to the marginal angle of another feature).

Additionally, a user swipe on an ad that identifies a specific call-to-action (CTA) can be considered higher-quality signals to the machine learning model as compared to taps, which are more deliberate actions that could be associated with a higher likelihood of conversion. Detailed swipe gesture metrics, including angle, speed, and distance, can help refine user experience by ensuring that gestures are intuitive and distinct enough to prevent accidental interactions. In other cases, changes in how a user responds to an ad call-to-action (CTA), e.g. swiping versus tapping, can be used as a quality signal for the machine learning model, with the tapping considered a more deliberate action that could be associated with a higher likelihood of conversion.

In some cases, the interaction system gathers a tap source metric that identifies the specific surface or element on which a user taps to express interest or activate a feature within an application or an ad. There can be multiple surfaces or touch points within an app interface that users can interact with, such as buttons, images, links, or other interactive elements. Each of these surfaces might be positioned differently on the screen, and their proximity to the user's finger can significantly influence user behavior and interaction quality.

For instance, a tap on a prominently displayed call-to-action button at the center of the screen may indicate a deliberate and engaged action, whereas a tap on a smaller, less prominent link might suggest a different level of user intent or interest. In other cases, a tap on a less prominently displayed call-to-action button can be considered to be more deliberate. By analyzing the tap source, the machine learning model can gain insights into which elements of the interface are more effective in capturing user attention and driving engagement. This information can then be used to determine, based on the placement and design of interactive elements of the application or ad, the click quality of the user.

In some cases, the interaction system determines a user's speed metric on the webpage, such as when organic content is being displayed. This metric assesses how quickly users navigate through organic content, such as feeds or lists, within an application. This behavior is indicative of user intent and engagement level. Specifically, users who rapidly swipe, scroll, or tap through organic content can be determined by the machine learning model to be a user of high engagement and may be more likely to click on ads or interactive elements because they are actively consuming and interacting with the content.

Although examples are described herein for one type of user action (e.g., swipe), it is appreciated that such features can also be applied to other types of user action, such as an advancing action, a scroll or tap.

In other cases, a faster tap speed can indicate to the machine learning model that the click may have a higher probability of being an accidental click. In some cases, a slower tap speed can indicate a more intentional engagement by the user, and thus, a click of an impression can be linked or associated with a higher quality click by the machine learning model.

In some cases, the interaction system measures a swipe distance metric. The swipe distance metric measures the actual physical distance a user's finger or cursor travels on the screen during a swipe gesture. This metric captures how far users move their finger or cursor in a single swipe action. The swipe distance metric can help the machine learning model determine engagement level and interaction style. For example, a longer swipe distance may indicate a more deliberate action, possibly reflecting a higher interest in the content.

In some cases, the interaction system measures a click duration metric indicative of the amount of time a user maintains contact with a screen element, such as a button or ad, before releasing it during the selection of the impression. This metric captures how long a user's finger or cursor stays pressed down on a clickable element. Click duration can provide valuable insights into user intent and engagement. For example, a longer click duration may indicate a higher level of interest or deliberation before taking action, whereas a shorter click duration might suggest a quick or accidental interaction.

In some cases, the interaction system applies user profile information into a machine learning model to enhance the model's ability to make more accurate inferences about user behavior and interaction quality. User profile data, such as demographics, past behavior, and preferences, provides context that can help the model better understand and predict how different types of users might interact with ads or content. For example, a model trained with profile information can learn that users of certain age groups or interests are more likely to engage with specific types of ads or content in particular ways.

During inference, user profile data allows the model to tailor its predictions based on individual characteristics and historical patterns. This means the model can better assess the likelihood of a click leading to a desired outcome by considering the user's unique profile in conjunction with their interaction metrics. This personalized approach helps improve the accuracy of click quality assessments and optimizes ad targeting strategies.

Profile data of users includes personal information, such as a name, email address, phone number, date of birth, gender, education, occupation, interests, and/or the like. Profile data of users includes profile pictures, cover photos, biographies, and any other customizations made by the user to their online profiles. Profile data of users includes connections and relationships with other users, such as a user's friends, followers, and connections, as well as the groups and pages they follow or like. Profile data of users includes content users share, such as text, photos, videos, and links, and direct messages, comments, and any other interactions users have within the platform. Profile data of users includes location data, such as the user's city or precise GPS coordinates, such as when using location-based features or when sharing content with location tags. Profile data of users includes how users interact with the platform's services, such as the content they view, like, share, or engage with, as well as the features they use and the duration of their sessions. Profile data of users includes data about the devices used to access their services, including device model, operating system, browser type, IP address, and unique identifiers like device IDs or cookies.

In some cases, the interaction system generates an Estimated Advertiser Value (EAV) that quantifies the potential value an ad holds for a user (e.g., in terms of dollar values), based on various predictive factors. The interaction system can calculate EAV by multiplying the probability of a specific event occurring (such as a swipe or purchase) by the value assigned to that event. This calculation can leverage extensive user data (such as user profile data), including consumption patterns, interaction history with other ads, hobbies, and demographics, to generate an informed prediction of how valuable the ad is to the user. The EAV reflects how well the ad aligns with the user's interests and preferences, providing a measure of the ad's effectiveness and potential return on investment for advertisers.

The EAV serves as a powerful signal to the machine learning model as well as in the ad auction process. Ads with a higher EAV indicate a better match with the user's profile and a greater likelihood of engagement or conversion. Consequently, such ads are often prioritized in bidding and placement strategies. By incorporating this metric, machine learning models can more accurately assess and predict the quality of ad interactions, ultimately reducing the chances of low-quality clicks.

In some cases, the EAV can be used as a metric to quantify the potential value an ad delivers to the advertiser. In this scenario, EAV represents the anticipated return on investment for the advertiser based on predicted user interactions and conversions. The interaction system calculates this advertiser-focused EAV by considering factors such as the likelihood of user engagement, the expected conversion rates, and the projected revenue generated from those conversions. By analyzing past performance data, market trends, and the advertiser's specific goals, the EAV provides a comprehensive measure of the ad's potential to achieve the desired business outcomes, helping advertisers optimize their campaigns and allocate resources more effectively.

Although the examples described herein explain EAV, it is appreciated that other values can be applied to such features, such as an estimated organic value (EOV).

In some cases, the interaction system accesses geolocation metrics related to the user's country or regional group, such as US, Europe, or the Middle East. The geolocation metric can significantly impact ad quality prediction. Different regions may have distinct user behaviors and preferences. For example, users in different countries might interact with the app differently due to cultural differences or varying levels of familiarity with technology. In the US, users might engage more quickly with content, while in other regions, the interaction might be slower or more deliberate. This regional variation helps the model understand the context in which the user is operating and predict the likelihood of a successful ad interaction more accurately.

In some cases, the interaction system identifies the type of browser used to access the ad, which can affect the visibility and interaction metrics of the ad. When users are redirected to an external browser, the app's tracking capabilities are limited until the user returns. However, when users stay within the app's internal browser, the system can capture more detailed interaction data. This difference in tracking capability can be accounted for in the model to adjust the prediction of ad quality based on how well the system can monitor user behavior.

In some cases, the interaction system identifies the age of the user which can influence how they interact with ads. Younger users might be more exploratory and less deliberate, clicking around more frequently, while older users might approach ad interactions with more intention. The machine learning model may segment users into age brackets, such as 13-17, 18-24, 25-34, and 35+, allowing the model to tailor predictions based on typical behavior patterns associated with each age group.

In some cases, the interaction system identifies the gender of the user. The gender metric can help in refining ad predictions based on gender-specific behavior patterns. For example, engagement levels and interests can vary between genders, affecting how likely a user is to interact with certain types of ads.

In some cases, the interaction system can identify a platform and/or device of the user. The platform used (mobile phone, PC, tablet, or smart watch) can also impact how users interact with ads. Different platforms have unique user interfaces and interaction styles, which can affect the way users engage with content. For example, mobile users might interact differently compared to PC users. Understanding the platform and device preferences allows the model to account for these variations and improve the prediction of ad quality based on platform-specific behavior.

In some cases, the interaction system identifies medium or channel metrics to train machine learning models to generate accurate conversion probabilities. Such metrics can provide context-specific insights into how users interact with ads across different surfaces and media types within the app.

By understanding which inventory or distribution channel the ad appears on, as well as the media type of the ad, the model can better gauge user engagement and likelihood of conversion and how such channels interplay with other data described herein. For instance, an ad displayed in a fast-scrolling post list of friends might be less noticeable compared to one featured in a more focused, slower-viewed section such as a sports show. Additionally, knowing whether an ad is skippable or not further refines the model's ability to predict conversion probabilities by accounting for variations in user attention and engagement.

In some cases, the interaction system identifies a distribution channel metric that includes the specific surface or context within the app where the ad is displayed. Different distribution channels affect how users interact with content. For example, users might scroll rapidly through a series of photos in a friend's post, leading to less focused engagement with any single ad. Conversely, an ad placed in a slower-paced section such as a sports show might receive more attention. By analyzing the performance of ads across these various channels, the model can determine how the context influences user engagement and adjust conversion probabilities accordingly.

In some cases, the interaction system identifies a media type and/or skippability of videos. Media type includes whether the ad is static or video, and whether it is skippable. Static ads might not capture as much user attention compared to video ads, which often engage users more effectively through motion and sound. Additionally, skippable ads provide users with the option to bypass the ad, potentially affecting how long users engage with the content. Analyzing these factors can help the model understand the varying levels of user interaction and attention, improving its ability to predict which ads are more likely to lead to conversions.

In some cases, the interaction system accesses ad interaction position (e.g., X/Y coordinates). The ad interaction position can include specific coordinates on the screen where a user initiates their interaction with an ad. This metric captures whether the user starts engaging with the ad from the top, bottom, or sides of the screen.

Variations in interaction quality can be observed based on these positions. For example, interactions that occur in more central or prominent areas of the screen might indicate higher user focus and engagement compared to those at the edges or in less visible regions. This variation could be due to the ad's placement relative to other organic content and call-to-action (CTA) buttons and navigational gestures, which might impact how users notice and engage with the ad. Understanding these positional nuances helps the machine learning model in determining how much of the ad placement is affecting the user behavior, of which many examples are provided herein.

In some cases, the interaction system gathers metrics as described herein over a predefined time period, such as the past 10 seconds, the past 3 seconds from a user's click of an impression, etc.

At block 404, the interaction client processes the user interaction data and the conversion data via a machine learning model. Processing such data through the machine learning model trains the machine learning model to infer a conversion probability based on new user interaction data, such as from a first user.

In some examples, the interaction system applies a boosted random forest model. Such a model is a type of ensemble learning method that enhances predictive performance by combining multiple decision trees. During the training phase, this model is fed with historical data that includes various features such as user interactions, click behavior, and conversion outcomes. By analyzing these features, the model learns patterns and relationships between different interaction metrics and their likelihood of leading to conversions.

The training process involves adjusting the model's parameters to minimize errors and improve its ability to predict conversion probabilities. For instance, the model learns that users who interact with ads in central screen positions or who show high swipe intensity are more likely to convert.

This is achieved by iteratively updating the model based on feedback from the data, where each tree in the forest contributes to a more accurate final prediction. As the model processes more interaction and conversion data, it becomes better at identifying which patterns are most indicative of successful ad engagements, thereby refining its ability to predict conversion probabilities for new users.

At block 406, the interaction client displays an impression on a user interface of the application to a first user. In digital advertising, an impression includes an instance where an ad or promotional content is shown to a user on their screen. This occurs when the ad is loaded and visible in the user's viewport, regardless of whether or not the user interacts with it. Impressions are a fundamental metric in ad tracking and measurement, as they indicate the exposure of the advertisement to potential viewers.

Impressions can take various forms depending on the platform and the type of ad being served. For instance, in a social media app, an impression could involve a user viewing a sponsored story, a banner ad, or a full-screen video ad. The context in which the impression is displayed can influence its effectiveness. Ads shown in prominent positions or integrated within engaging content might have higher visibility compared to those in less visible areas.

As shown in FIG. 5, the interaction system can retrieve an impression from an impression database 518 and display the impression to a first user 516.

At block 408, the interaction client determines that the first user has selected the displayed impression. The interaction client detects and/or confirms user interaction with the ad or promotional content that was shown to them. Selection of an impression can occur through various user actions depending on the nature of the ad and the interface design of the application.

For example, in a mobile app, the user might select an impression by tapping on an ad banner or clicking on a sponsored post. In the case of a video ad, selecting the impression could involve pressing a “play” button or engaging with interactive elements within the video, such as buttons or links. For full-screen ads or interstitials, selection might be registered when the user swipes or taps to proceed through the ad or to access additional content.

In other scenarios, selection could involve more nuanced interactions. For instance, if the ad is embedded within a social media feed, the user might scroll through and pause to view the ad, or they might tap to expand the ad for more details. In e-commerce ads, selecting an impression could be as simple as clicking on a product ad to view more information or to add the item to a cart. Each of these actions signifies that the user has actively engaged with the ad, providing valuable data on user interest and the effectiveness of the ad placement.

At block 410, the interaction client accesses first user interaction data of a first user indicative of first user click behavior. The interaction client gathers and reviews data on how the user engaged with the ad, such as whether they clicked on it, how long they interacted with it, and any specific actions they took (as further described herein). The interaction client monitors various click-related metrics, such as the time spent on the ad, the type of click (e.g., tap, double-tap), and any subsequent user actions.

Even if the ad directs the user to a third-party site where direct tracking may be limited, the interaction client can still collect valuable data. For instance, if the ad leads to an external website, the client may record when the user exits the app and when they return, providing insight into their engagement level before and after leaving the app. This data helps the model to understand user behavior and can use this data to generate a conversion probability.

At block 412, the interaction client processes the first user interaction data via the machine learning model to generate a conversion probability. The collected interaction data is transformed into features suitable for the machine learning model. This process can involve encoding raw data into a structured format that the model can interpret. For example, click duration might be converted into numerical values representing different levels of engagement, or user actions might be categorized based on their likelihood to lead to conversion.

The processed data is fed into a pre-trained machine learning model, which has been trained on historical data to understand patterns associated with conversions. The model outputs a conversion probability as a percentage, which represents the likelihood that the first user will perform a desired action, such as making a purchase or signing up for a service. This probability is derived from the model's understanding of how similar interactions in the past have correlated with conversions, adjusted for the specifics of the current interaction.

At block 414, the interaction client determines whether the selection of the first user of the displayed impression is a low-quality click based on the conversion probability. The interaction system can compare the generated conversion probability against established criteria for low-quality interactions. The interaction client uses the conversion probability to gauge the likelihood that the first user's click will lead to a desired outcome, such as making a purchase or completing a sign-up. The probability value reflects how likely it is, based on the available interaction data, that the first user will convert.

By comparing the first user's conversion probability against thresholds or patterns identified from historical data, the interaction client can infer whether the click is likely to be low-quality. For instance, if the conversion probability is lower than the typical threshold for quality clicks, the interaction system can determine that the interaction is less likely to result in a successful conversion and is therefore of lower quality. Additionally, the model might use known patterns of low-quality behavior from similar users to further assess the likelihood of the click being low-quality.

When evaluating the quality of clicks, the interaction client can classify clicks, such as a mid-quality or high-quality click based on the conversion probability and/or the historical data.

For a mid-quality click, the interaction system can look for a conversion probability to be between the thresholds set for low and high-quality clicks, whereas for high-quality clicks, the interaction system assesses whether the conversion probability is above a certain threshold. When a click is identified as high-quality, the interaction client can prioritize these interactions for favorable outcomes.

In FIG. 5, the first user behavior 520 can be processed by the machine learning model 514. The machine learning model here is trained to generate a click quality metric 522, such as a conversion probability. In some cases, the machine learning model provides insights into user segmentation. By analyzing patterns and behaviors across different user groups, the model can identify segments that are more or less likely to convert based on user interactions.

This segmentation can be based on demographics, interaction history, or other profile attributes. For example, the model might reveal that users within a certain age group or geographic location have higher conversion probabilities, allowing for more targeted and effective ad placements.

In some cases, the model can forecast the effectiveness of various ads and predict their future performance for the first user. By evaluating historical data and interaction patterns, the model can estimate how well different ads are likely to perform in future campaigns. This forecasting capability helps advertisers allocate their budgets more efficiently and prioritize ads with higher expected returns.

The model can offer recommendations for optimizing ad campaigns for the first user based on the click quality metrics it generates. For instance, the model may suggest changes in ad creative, targeting parameters, or placement strategies to improve conversion rates. By leveraging these recommendations, advertisers and/or the data platform can refine their approaches and enhance the effectiveness of their campaigns.

The machine learning model can contribute to personalizing the user experience by tailoring ads based on predicted click quality and user preferences. For example, ads that are predicted to have high conversion probabilities for a particular user can be shown more frequently or with more prominent placements. Personalization helps in increasing engagement and satisfaction by delivering more relevant and appealing ad content to users.

The model can also be used to detect anomalies in user behavior or ad performance. For example, if a particular ad's click quality metric significantly deviates from the norm, the model can indicate issues such as ad fraud, a technical problem, or unexpected changes in user behavior. Identifying these anomalies allows for quick intervention and adjustment to maintain the quality and integrity of ad campaigns.

The model can analyze and compare ad performance across different channels and platforms based on the user interaction. By evaluating how ads perform on various surfaces (e.g., social media, search engines, websites), the model provides insights into which channels yield the highest conversion rates. This cross-channel analysis helps in optimizing multi-channel marketing strategies and improving overall ad spend efficiency.

Systems and methods described herein include training a machine learning network, such as training to determine conversion probabilities. The machine learning network can be trained to determine conversion probabilities. The machine learning algorithm can be trained using historical information that include historical user interaction data and conversion data.

Training of models, such as artificial intelligence models, is necessarily rooted in computer technology, and improves modeling technology by using training data to train such models and thereafter applying the models to new inputs to make inferences on the new inputs. Here, the new inputs can be a new interaction data of the first user. The trained machine learning model can determine an ad click quality of that first user based on such new interaction data.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new interaction data) and make predictions that the model was trained for based on the weights or scores that were adjusted during training. Such training of the machine learning models described herein reduces false positives and increases the performance.

### MACHINE LEARNING MODEL AGNOSTIC TO AD CHARACTERISTICS

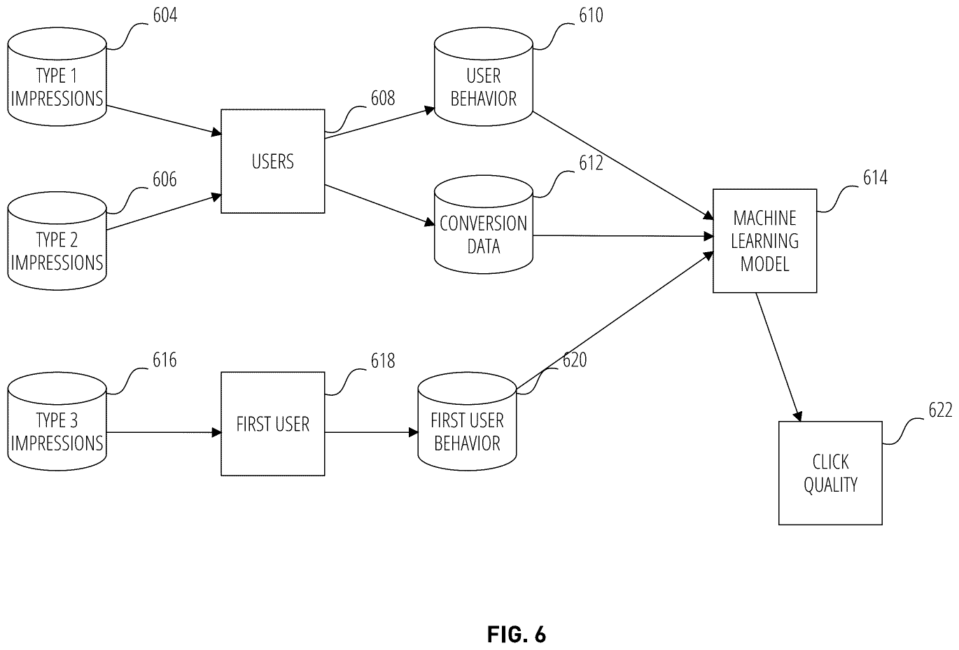

FIG. 6 illustrates a machine learning model that can infer ad quality regardless of ad characteristics, according to some examples. The system is designed to be agnostic to the specific characteristics of ads. For example, the machine learning model can infer ad click quality regardless of ad content, such as text, static images or graphics, video content, whether short clips or longer-form videos, ads that require user interaction, such as clicking, swiping, or playing a game, or the like.

The machine learning model can infer ad click quality regardless of ad placement, such as ads placed at the top of a user's content feed, ads displayed on the side of the screen, ads embedded within stories or content feeds, full-screen ads that appear at transition points, such as between activities or screens, or ads that pop up over the current screen content.

The machine learning model can infer ad click quality regardless of ad format, such as horizontal or vertical banners usually placed at the top or bottom of the screen, ads that blend with the content and design of the platform they appear on, ads that allow users to swipe through multiple images or videos, or ads that appear as regular posts within social media feeds.

The machine learning model can infer ad click quality regardless of ad type, such as non-moving ads, such as images or text, ads that change based on user interactions or external factors (e.g., weather), ads that users can skip after a certain period, or ads that must be watched in full before proceeding.

The machine learning model can infer ad click quality regardless of the type of call to action, such as ads that direct users to an external website or page, ads prompting users to download and install an application, ads encouraging users to watch a video, or ads asking users to sign up for a service or subscribe to a newsletter.

The machine learning model can infer ad click quality regardless of ad size, such as compact ads that occupy minimal screen space, moderately sized ads that take up more space but are not full-screen, or ads that take up significant screen real estate, possibly full-screen.

The machine learning model can infer ad click quality regardless of ad frequency, such as ads that are shown to the user once or ads that appear multiple times to the same user over a period.

The machine learning model can infer ad click quality regardless of ad targeting criteria, such as ads tailored to specific demographic groups (age, gender, etc.), ads based on user behavior, such as browsing history or past purchases, or ads targeted based on user location.

The machine learning model can infer ad click quality regardless of ad content, such as ads related to the specific content the user is viewing, or ads that are not related to the specific content but are shown based on other targeting criteria.

The machine learning model can infer ad click quality regardless of ad interaction mechanisms, such as ads that require clicking to interact, ads that involve swiping actions to interact, ads that respond to hovering (more common in desktop environments), or ads that can be interacted with via voice commands.

The machine learning model can infer ad click quality regardless of ad timing, such as ads shown before the main content, ads shown in the middle of content, or ads shown after the content has finished.

The machine learning model can infer ad click quality regardless of ad delivery platform, such as ads delivered on mobile devices, ads delivered on desktop or laptop computers, ads delivered on tablet devices, or ads delivered through smart TV applications.

The machine learning model can infer ad click quality regardless of user engagement requirements, such as ads that do not require any user interaction, or ads that require user interaction to proceed or complete.

By being agnostic to these characteristics, the system can effectively use user interaction data to assess click quality across various ad types and contexts, ensuring a robust and versatile approach to identifying low-quality clicks.

By being agnostic to these characteristics, the system can effectively use user interaction data to assess click quality across various ad types and contexts, ensuring a robust and versatile approach to identifying low-quality clicks. The key to this agnosticism lies in the system's focus on input features that are common across all ads, regardless of their specific characteristics.

These features, which are consistently present in both the training data and the prediction data, allow the model to generalize its learning and apply it to a wide range of scenarios. This means that the model isn't tied to any particular ad format, channel, or content type; instead, the model relies on universally applicable data points that remain relevant no matter the context.

By considering these common features, the system ensures that the model remains adaptable and scalable, extending the model's predictive capabilities beyond the specific conditions under which it was initially trained. This approach allows the model to maintain its accuracy and effectiveness even when encountering new or previously unseen ad types and contexts.

For instance, if a new ad format is introduced that the model hasn't explicitly been trained on, the model can still evaluate click quality based on the fundamental user interaction data the model has been trained to recognize. This extensibility is an important feature, as it allows the model to evolve alongside the dynamic and rapidly changing landscape of digital advertising without requiring constant retraining or adjustment to accommodate new ad formats or distribution channels.

Moreover, this feature-agnostic approach makes the system inherently more resilient to changes in ad design and presentation, as the system doesn't depend on specific, potentially transient characteristics. Instead, the system focuses on the core interactions between users and ads, which are more stable over time. This enables the model to deliver consistent performance and maintain its ability to detect low-quality clicks, ensuring that advertisers receive accurate assessments of ad effectiveness, regardless of the evolving nature of the ads themselves.

In FIG. 6, the interaction system gathers interaction data 610, 612 on a number of different users 608 with a first type of ad (e.g., video ad) 604 and a second type of ad 606. This includes clicks, views, swipes, and any other engagement metrics.

The first type of ad and the second type of ad can be different based on the characteristics that the machine learning model is agnostic to (as further described herein).

The machine learning model tracks specific user behavior metrics such as viewing time, swipe angle, click duration, and interaction intensity for these different types of ads and accesses or records conversion events (e.g., purchases, sign-ups) to associate interactions with successful outcomes.

The interaction system processes the user interaction data for the first and second type of ads and conversion data via the machine learning model to train the machine learning model to learn patterns in the user interactions that lead to conversions and those that do not, regardless of the ad type.

Then, the interaction system gathers data on a first user 618 of user interactions 620 with a third type of ad (e.g., interactive ad) 616 that is different than the first or second type of ad. From the collected data on the third type of ad, the system processes the user interactions via the machine learning model to generate a conversion probability and/or click quality metric 622 for the new user interactions.

By following these steps, the system can effectively leverage historical user interaction data from various types of ads to predict ad quality for new user interactions, regardless of the ad's specific characteristics.

### DATA COMMUNICATIONS ARCHITECTURE

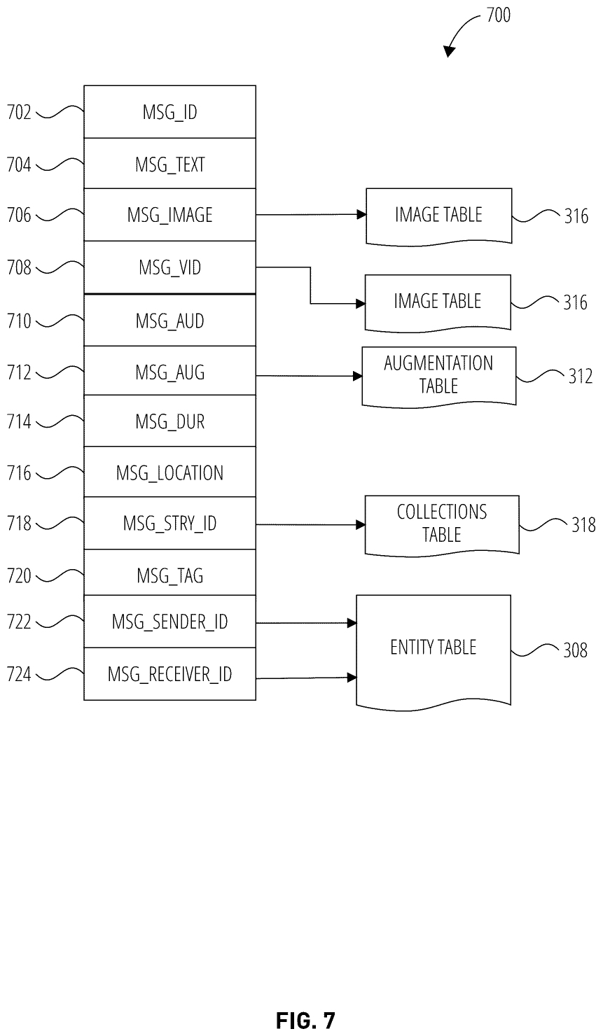

FIG. 7 is a schematic diagram illustrating a structure of a message 700, according to some examples, generated by an interaction client 104 for communication to a further interaction client 104 via the interaction servers 124. The content of a particular message 700 is used to populate the message table 306 stored within the database 304, accessible by the interaction servers 124. Similarly, the content of a message 700 is stored in memory as “in-transit” or “in-flight” data of the user system 102 or the interaction servers 124. A message 700 is shown to include the following example components:
Message identifier 702: a unique identifier that identifies the message 700.
Message text payload 704: text, to be generated by a user via a user interface of the user system 102, and that is included in the message 700.
Message image payload 706: image data, captured by a camera component of a user system 102 or retrieved from a memory component of a user system 102, and that is included in the message 700. Image data for a sent or received message 700 may be stored in the image table 316.
Message video payload 708: video data, captured by a camera component or retrieved from a memory component of the user system 102, and that is included in the message 700. Video data for a sent or received message 700 may be stored in the image table 316.
Message audio payload 710: audio data, captured by a microphone or retrieved from a memory component of the user system 102, and that is included in the message 700.
Message augmentation data 712: augmentation data (e.g., filters, stickers, or other annotations or enhancements) that represents augmentations to be applied to message image payload 706, message video payload 708, or message audio payload 710 of the message 700. Augmentation data for a sent or received message 700 may be stored in the augmentation table 312.
Message duration parameter 714: parameter value indicating, in seconds, the amount of time for which content of the message (e.g., the message image payload 706, message video payload 708, message audio payload 710) is to be presented or made accessible to a user via the interaction client 104.
Message geolocation parameter 716: geolocation data (e.g., latitudinal and longitudinal coordinates) associated with the content payload of the message. Multiple message geolocation parameter 716 values may be included in the payload, each of these parameter values being associated with respect to content items included in the content (e.g., a specific image within the message image payload 706, or a specific video in the message video payload 708).
Message story identifier 718: identifier values identifying one or more content collections (e.g., “stories” identified in the collections table 318) with which a particular content item in the message image payload 706 of the message 700 is associated. For example, multiple images within the message image payload 706 may each be associated with multiple content collections using identifier values.
Message tag 720: each message 700 may be tagged with multiple tags, each of which is indicative of the subject matter of content included in the message payload. For example, where a particular image included in the message image payload 706 depicts an animal (e.g., a lion), a tag value may be included within the message tag 720 that is indicative of the relevant animal. Tag values may be generated manually, based on user input, or may be automatically generated using, for example, image recognition.
Message sender identifier 722: an identifier (e.g., a messaging system identifier, email address, or device identifier) indicative of a user of the user system 102 on which the message 700 was generated and from which the message 700 was sent.
Message receiver identifier 724: an identifier (e.g., a messaging system identifier, email address, or device identifier) indicative of a user of the user system 102 to which the message 700 is addressed.

The contents (e.g., values) of the various components of message 700 may be pointers to locations in tables within which content data values are stored. For example, an image value in the message image payload 706 may be a pointer to (or address of) a location within an image table 316. Similarly, values within the message video payload 708 may point to data stored within an image or video table 316, values stored within the message augmentation data may point to data stored in an augmentation table 312, values stored within the message story identifier 718 may point to data stored in a collections table 318, and values stored within the message sender identifier 722 and the message receiver identifier 724 may point to user records stored within an entity table 308.

### SYSTEM WITH HEAD-WEARABLE APPARATUS

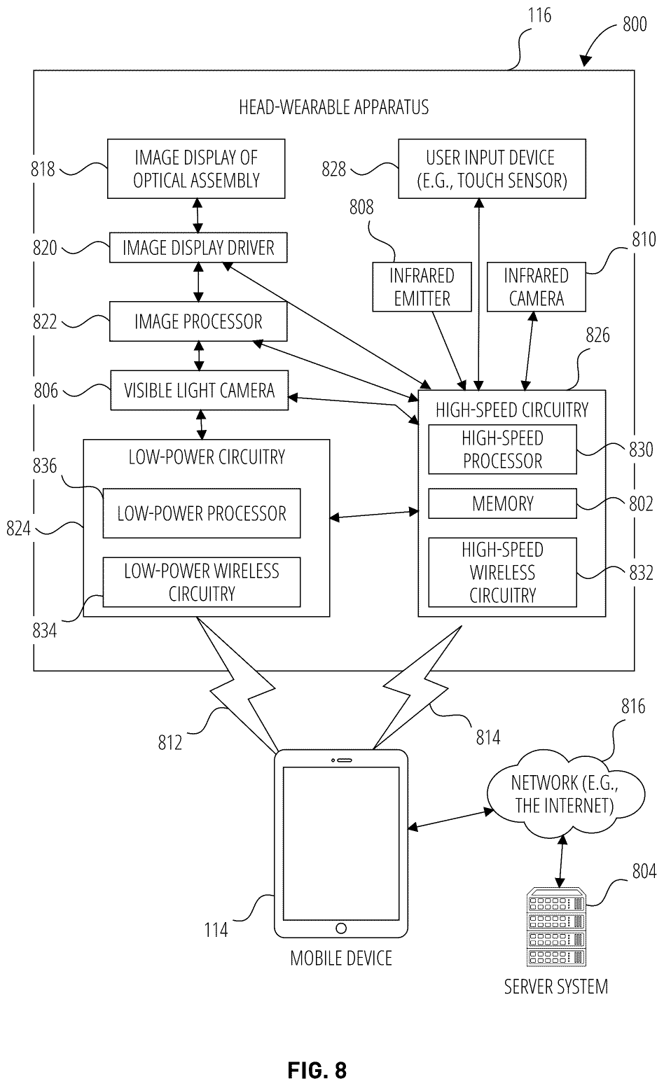

FIG. 8 illustrates a system 800 including a head-wearable apparatus 116 with a selector input device, according to some examples. FIG. 8 is a high-level functional block diagram of an example head-wearable apparatus 116 communicatively coupled to a mobile device 114 and various server systems 804 (e.g., the interaction server system 110) via various networks 108. The networks 108 may include any combination of wired and wireless connections.

The head-wearable apparatus 116 includes one or more cameras, each of which may be, for example, a visible light camera 806, an infrared emitter 808, and an infrared camera 810.

An interaction client, such as a mobile device 114 connects with head-wearable apparatus 116 using both a low-power wireless connection 812 and a high-speed wireless connection 814. The mobile device 114 is also connected to the server system 804 and the network 816.

The head-wearable apparatus 116 further includes two image displays of the image display of optical assembly 818. The two image displays of optical assembly 818 include one associated with the left lateral side and one associated with the right lateral side of the head-wearable apparatus 116. The head-wearable apparatus 116 also includes an image display driver 820, an image processor 822, low-power circuitry 824, and high-speed circuitry 826. The image display of optical assembly 818 is for presenting images and videos, including an image that can include a graphical user interface to a user of the head-wearable apparatus 116.

The image display driver 820 commands and controls the image display of optical assembly 818. The image display driver 820 may deliver image data directly to the image display of optical assembly 818 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 828 (e.g., touch sensor or push button), including an input surface on the head-wearable apparatus 116. The user input device 828 (e.g., touch sensor or push button) is to receive from the user an input selection to manipulate the graphical user interface of the presented image.

The components shown in FIG. 8 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 806 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 802, which stores instructions to perform a subset or all of the functions described herein. The memory 802 can also include storage device.

As shown in FIG. 8, the high-speed circuitry 826 includes a high-speed processor 830, a memory 802, and high-speed wireless circuitry 832. In some examples, the image display driver 820 is coupled to the high-speed circuitry 826 and operated by the high-speed processor 830 in order to drive the left and right image displays of the image display of optical assembly 818. The high-speed processor 830 may be any processor capable of managing high-speed communications and operation of any general computing system needed for the head-wearable apparatus 116. The high-speed processor 830 includes processing resources needed for managing high-speed data transfers on a high-speed wireless connection 814 to a wireless local area network (WLAN) using the high-speed wireless circuitry 832. In certain examples, the high-speed processor 830 executes an operating system such as a LINUX operating system or other such operating system of the head-wearable apparatus 116, and the operating system is stored in the memory 802 for execution. In addition to any other responsibilities, the high-speed processor 830 executing a software architecture for the head-wearable apparatus 116 is used to manage data transfers with high-speed wireless circuitry 832. In certain examples, the high-speed wireless circuitry 832 is configured to implement Institute of Electrical and Electronic Engineers (IEEE) 802.11 communication standards, also referred to herein as WI-FI®. In some examples, other high-speed communications standards may be implemented by the high-speed wireless circuitry 832.

The low-power wireless circuitry 834 and the high-speed wireless circuitry 832 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 812 and the high-speed wireless connection 814, may be implemented using details of the architecture of the head-wearable apparatus 116, as can other elements of the network 816.

The memory 802 includes any storage device capable of storing various data and applications, including, among other things, camera data generated by the left and right visible light cameras 806, the infrared camera 810, and the image processor 822, as well as images generated for display by the image display driver 820 on the image displays of the image display of optical assembly 818. While the memory 802 is shown as integrated with high-speed circuitry 826, in some examples, the memory 802 may be an independent standalone element of the head-wearable apparatus 116. In certain such examples, electrical routing lines may provide a connection through a chip that includes the high-speed processor 830 from the image processor 822 or the low-power processor 836 to the memory 802. In some examples, the high-speed processor 830 may manage addressing of the memory 802 such that the low-power processor 836 will boot the high-speed processor 830 any time that a read or write operation involving memory 802 is needed.

As shown in FIG. 8, the low-power processor 836 or high-speed processor 830 of the head-wearable apparatus 116 can be coupled to the camera (visible light camera 806, infrared emitter 808, or infrared camera 810), the image display driver 820, the user input device 828 (e.g., touch sensor or push button), and the memory 802.

The head-wearable apparatus 116 is connected to a host computer. For example, the head-wearable apparatus 116 is paired with the mobile device 114 via the high-speed wireless connection 814 or connected to the server system 804 via the network 816. The server system 804 may be one or more computing devices as part of a service or network computing system, for example, that includes a processor, a memory, and network communication interface to communicate over the network 816 with the mobile device 114 and the head-wearable apparatus 116.

The mobile device 114 includes a processor and a network communication interface coupled to the processor. The network communication interface allows for communication over the network 816, low-power wireless connection 812, or high-speed wireless connection 814. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 820. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 804, such as the user input device 828, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 812 and high-speed wireless connection 814 from the mobile device 114 via the low-power wireless circuitry 834 or high-speed wireless circuitry 832.

### MACHINE ARCHITECTURE

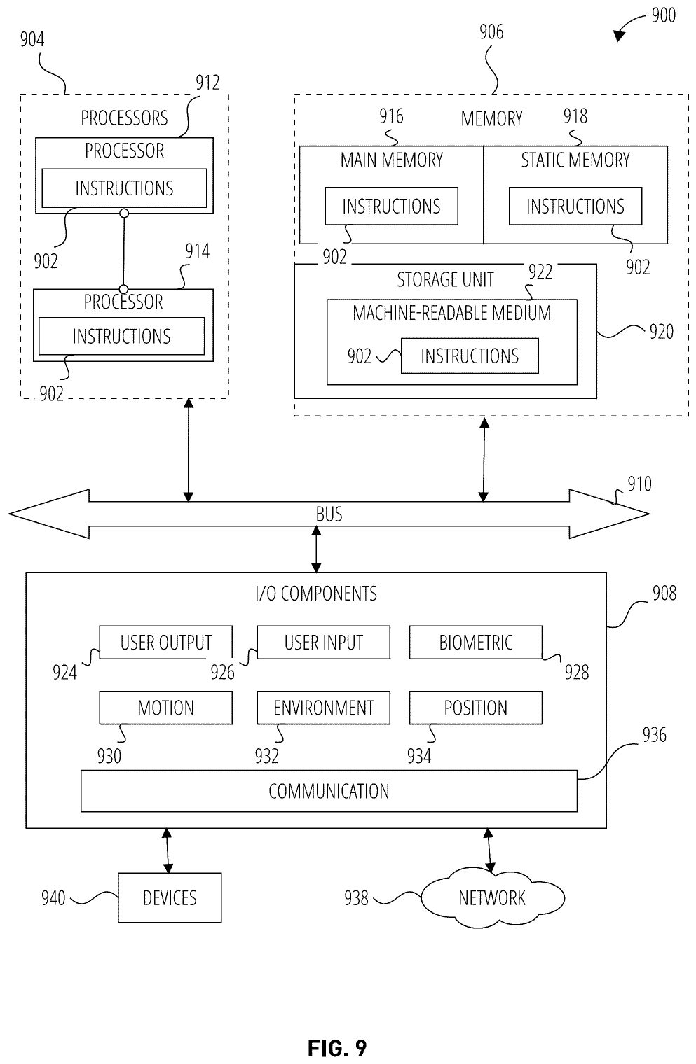

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the interaction server system 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### SOFTWARE ARCHITECTURE

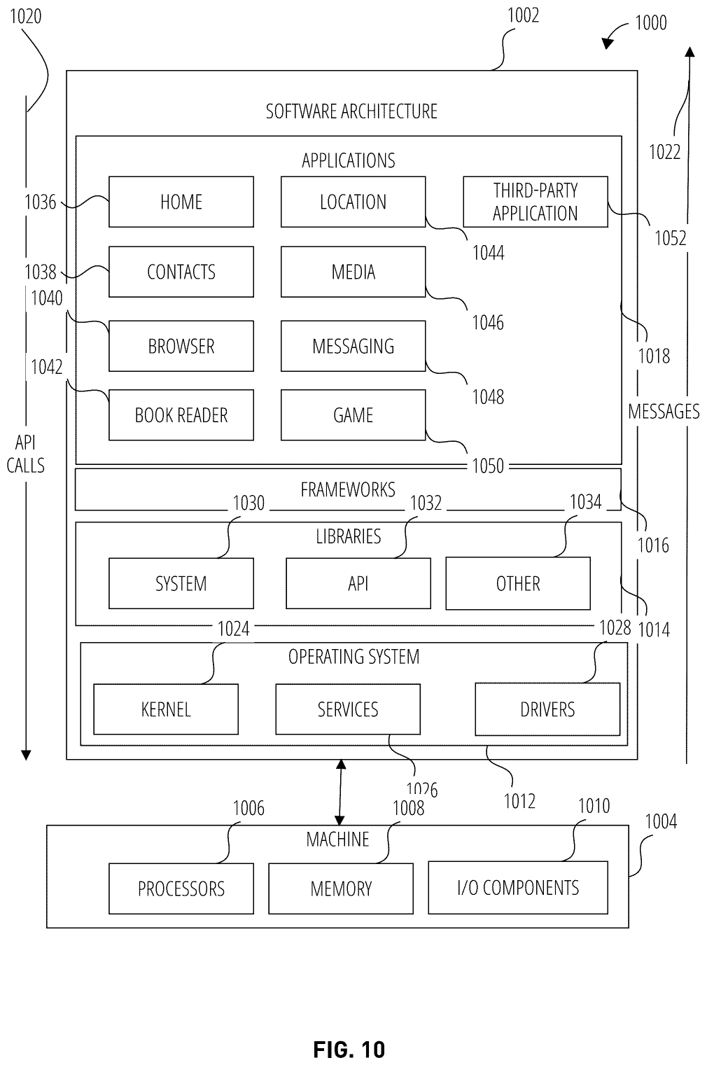

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

### MACHINE-LEARNING PIPELINE

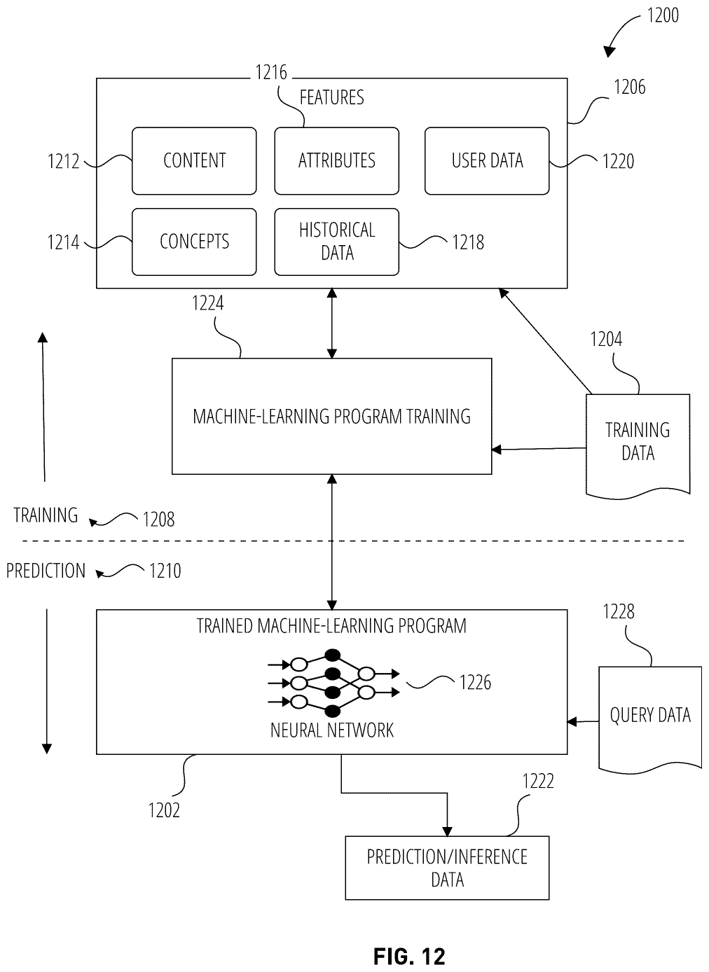

FIG. 12 is a flowchart depicting a machine-learning pipeline 1200, according to some examples. The machine-learning pipelines 1200 may be used to generate a trained model, for example the trained machine-learning program 1202 of FIG. 12, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

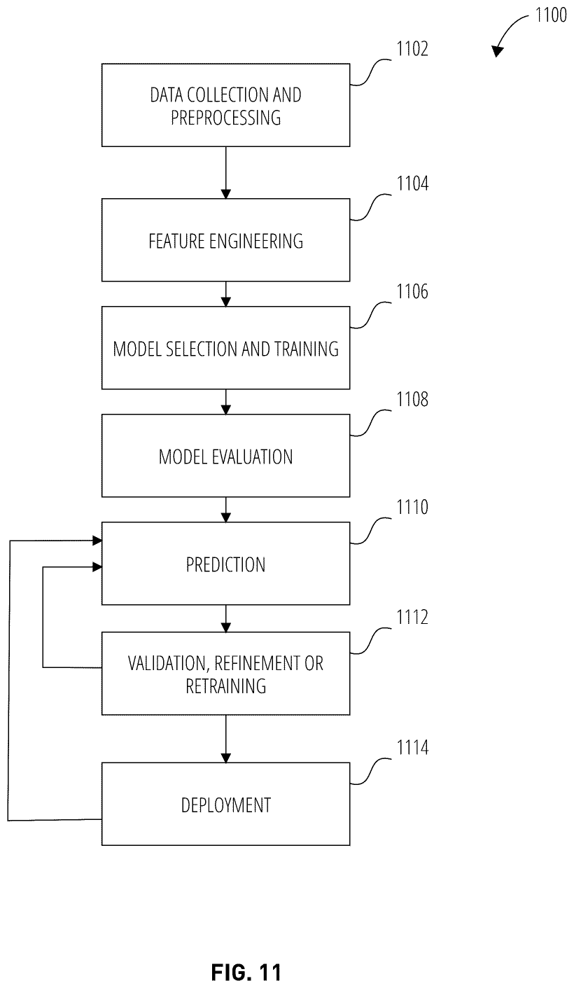

Generating a trained machine-learning program 1202 may include multiple types of phases that form part of the machine-learning pipeline 1200, including for example the following phases 1100 illustrated in FIG. 11:
Data collection and preprocessing 1102: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1104: This may include selecting and transforming the training data 1204 to create features that are useful for predicting the target variable. Feature engineering may include (1) receiving features 1206 (e.g., as structured or labeled data in supervised learning) and/or (2) identifying features 1206 (e.g., unstructured or unlabeled data for unsupervised learning) in training data 1204.
Model selection and training 1106: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1108: This may include evaluating the performance of a trained model (e.g., the trained machine-learning program 1202) on a separate testing dataset. This can help determine if the model is overfitting or underfitting and if it is suitable for deployment.
Prediction 1110: This involves using a trained model (e.g., trained machine-learning program 1202) to generate predictions on new, unseen data.
Validation, refinement or retraining 1112: This may include updating a model based on feedback generated from the prediction phase, such as new data or user feedback.
Deployment 1114: This may include integrating the trained model (e.g., the trained machine-learning program 1202) into a larger system or application, such as a web service, mobile app, or IoT device. This can involve setting up APIs, building a user interface, and ensuring that the model is scalable and can handle large volumes of data.

FIG. 12 illustrates two example phases, namely a training phase 1208 (part of the model selection and trainings 1106) and a prediction phase 1210 (part of prediction 1110). Prior to the training phase 1208, feature engineering 1104 is used to identify features 1206. This may include identifying informative, discriminating, and independent features for the effective operation of the trained machine-learning program 1202 in pattern recognition, classification, and regression. In some examples, the training data 1204 includes labeled data, which is known data for pre-identified features 1206 and one or more outcomes.

Each of the features 1206 may be a variable or attribute, such as individual measurable property of a process, article, system, or phenomenon represented by a data set (e.g., the training data 1204). Features 1206 may also be of different types, such as numeric features, strings, vectors, matrices, encodings, and graphs, and may include one or more of content 1212, concepts 1214, attributes 1216, historical data 1218 and/or user data 1220, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1208, the machine-learning pipeline 1200 uses the training data 1204 to find correlations among the features 1206 that affect a predicted outcome or prediction/inference data 1222.

With the training data 1204 and the identified features 1206, the trained machine-learning program 1202 is trained during the training phase 1208 during machine-learning program training 1224. The machine-learning program training 1224 appraises values of the features 1206 as they correlate to the training data 1204. The result of the training is the trained machine-learning program 1202 (e.g., a trained or learned model).

Further, the training phase 1208 may involve machine learning, in which the training data 1204 is structured (e.g., labeled during preprocessing operations), and the trained machine-learning program 1202 implements a relatively simple neural network 1226 capable of performing, for example, classification and clustering operations. In other examples, the training phase 1208 may involve deep learning, in which the training data 1204 is unstructured, and the trained machine-learning program 1202 implements a deep neural network 1226 that is able to perform both feature extraction and classification/clustering operations.

A neural network 1226 may, in some examples, be generated during the training phase 1208, and implemented within the trained machine-learning program 1202. The neural network 1226 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1226 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1226 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1208, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1226 is iteratively trained by adjusting model parameters to minimize a specific loss function or maximize a certain objective. The system can continue to train the neural network 1226 by adjusting parameters based on the output of the validation, refinement, or retraining block 1112, and rerun the prediction 1110 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1226 even after deployment 1114 of the neural network 1226. The neural network 1226 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1210, the trained machine-learning program 1202 uses the features 1206 for analyzing query data 1228 to generate inferences, outcomes, or predictions, as examples of a prediction/inference data 1222. For example, during prediction phase 1210, the trained machine-learning program 1202 is used to generate an output. Query data 1228 is provided as an input to the trained machine-learning program 1202, and the trained machine-learning program 1202 generates the prediction/inference data 1222 as output, responsive to receipt of the query data 1228. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1202 may be a generative AI model. Generative AI is a term that may refer to any type of artificial intelligence that can create new content from training data 1204. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1222 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: accessing user interaction data of a plurality of users on an application and corresponding conversion data, the user interaction data including click behavior of the plurality of users; processing the user interaction data and the conversion data via a machine learning model to train the machine learning model, the machine learning model configured to be trained to infer a conversion probability based on new user interaction data; displaying a first impression on a user interface of the application to a first user; determining that the first user has selected the displayed first impression; accessing first user interaction data of a first user indicative of first user click behavior; processing the first user interaction data via the machine learning model to generate a conversion probability; and determining whether the selection of the first user of the displayed first impression is a low-quality click based on the conversion probability.

In Example 2, the subject matter of Example 1 includes, wherein at least a first subset of the user interaction data is of a first user interaction type that is not visible for the first user subsequent to the first user selecting the displayed first impression.

In Example 3, the subject matter of Example 2 includes, wherein at least a second subset of the user interaction data is of a second user interaction type that is visible for the first user subsequent to the first user selecting the displayed first impression, and the second subset of the user interaction data is used to train the machine learning model, and the first user interaction data of the second user interaction type is applied to the machine learning model to generate the conversion probability.

In Example 4, the subject matter of Example 3 includes, wherein the second user interaction type includes user behavior prior to a user's selection of an impression, wherein data corresponding to the second user interaction type is used to train the machine learning model and applied to the machine learning model to generate the conversion probability.

In Example 5, the subject matter of Examples 3-4 includes, wherein the second user interaction type includes user behavior subsequent to a user's selection of an impression, wherein data corresponding to the second user interaction type is used to train the machine learning model and applied to the machine learning model to generate the conversion probability.

In Example 6, the subject matter of Examples 1-5 includes, wherein at least a portion of the user interaction data and the first user interaction data is of a first user interaction type, the first user interaction type including a return to app (RTA) time metric that tracks a duration between a user leaving the the application in response to the user's selection of an impression and the same user's subsequent return to the application, wherein data corresponding to the first user interaction type is used to train the machine learning model and applied to the machine learning model to generate the conversion probability.

In Example 7, the subject matter of Examples 1-6 includes, wherein at least a portion of the user interaction data and the first user interaction data is of a first user interaction type, the first user interaction type including a time metric corresponding to a time that an impression is displayed to a user, wherein data corresponding to the first user interaction type is used to train the machine learning model and applied to the machine learning model to generate the conversion probability.

In Example 8, the subject matter of Examples 1-7 includes, wherein at least a portion of the user interaction data and the first user interaction data is of a first user interaction type, the first user interaction type including an interaction intensity metric that is associated with an intensely of a user interactions with the application, wherein data corresponding to the first user interaction type is used to train the machine learning model and applied to the machine learning model to generate the conversion probability.

In Example 9, the subject matter of Example 8 includes, wherein the interaction intensity metric includes a swipe angle metric indicative of an angle at which a user swipes on the application with his or her finger.

In Example 10, the subject matter of Examples 8-9 includes, wherein the interaction intensity metric includes a swipe metric, wherein the impression identifies a swipe as a call-to-action (CTA) for the impression.

In Example 11, the subject matter of Examples 1-10 includes, wherein at least a portion of the user interaction data and the first user interaction data is of a first user interaction type, the first user interaction type including a scroll speed metric that is associated with a speed of a user scrolling through content displayed on the application, wherein data corresponding to the first user interaction type is used to train the machine learning model and applied to the machine learning model to generate the conversion probability.

In Example 12, the subject matter of Examples 1-11 includes, wherein the first user selection of the displayed first impression is via a swipe, the operations further comprising determining a swipe distance metric that measures the distance a user's finger or cursor travels along a display in order to select the first impression, wherein at least a portion of the user interaction data and the first user interaction data is of a first user interaction type, the first user interaction type including the swipe distance metric that is associated with a speed of a user scrolling through content displayed on the application, wherein data corresponding to the first user interaction type is used to train the machine learning model and applied to the machine learning model to generate the conversion probability.

In Example 13, the subject matter of Examples 1-12 includes, wherein at least a portion of the user interaction data and the first user interaction data is of a first user interaction type, the first user interaction type including a click duration metric that is associated with an amount of time a user maintains contact with a user interface when selecting an impression, wherein data corresponding to the first user interaction type is used to train the machine learning model and applied to the machine learning model to generate the conversion probability.

In Example 14, the subject matter of Examples 1-13 includes, wherein the operations further comprise: determining a platform type of the first user, the machine learning model trained to receive different inputs based on differing platform types, processing the first user interaction data comprising inputting data of a certain user interaction type based on the platform type to the machine learning model and the machine learning model trained to generate the conversion probability based on the inputted data of the certain user interaction type.

In Example 15, the subject matter of Examples 1-14 includes, wherein the plurality of users are routed to an internal interaction function in response to the plurality of users selecting impressions, wherein the selection of the first impression by the first user results in the first user being routed to a third party system.

In Example 16, the subject matter of Examples 1-15 includes, wherein the plurality of users have opted-in to sharing third party data, wherein a selection of impressions by the plurality of users result in the plurality of users being routed to third party systems, wherein the selection of the first impression by the first user results in the first user being routed to a third party system.

In Example 17, the subject matter of Example 16 includes, wherein the first user has not opted-in to sharing third party data.

In Example 18, the subject matter of Examples 16-17 includes, wherein the user interaction data includes user interaction of the plurality of users of an ad type that is not the same ad type as the first impression selected by the first user, wherein the machine learning model is trained based on user interaction data that is not from the same ad type as the inference performed by the machine learning model to generate the conversion probability for the first user.

Example 19 is a method comprising: accessing user interaction data of a plurality of users on an application and corresponding conversion data, the user interaction data including click behavior of the plurality of users; processing the user interaction data and the conversion data via a machine learning model to train the machine learning model, the machine learning model configured to be trained to infer a conversion probability based on new user interaction data; displaying a first impression on a user interface of the application to a first user; determining that the first user has selected the displayed first impression; accessing first user interaction data of a first user indicative of first user click behavior; processing the first user interaction data via the machine learning model to generate a conversion probability; and determining whether the selection of the first user of the displayed first impression is a low-quality click based on the conversion probability.

Example 20 is a non-transitory computer-readable storage medium storing instructions that, when executed by at least one processor, cause the at least one processor to perform operations comprising: accessing user interaction data of a plurality of users on an application and corresponding conversion data, the user interaction data including click behavior of the plurality of users; processing the user interaction data and the conversion data via a machine learning model to train the machine learning model, the machine learning model configured to be trained to infer a conversion probability based on new user interaction data; displaying a first impression on a user interface of the application to a first user; determining that the first user has selected the displayed first impression; accessing first user interaction data of a first user indicative of first user click behavior; processing the first user interaction data via the machine learning model to generate a conversion probability; and determining whether the selection of the first user of the displayed first impression is a low-quality click based on the conversion probability.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
accessing user interaction data of a plurality of users on an application and corresponding conversion data, the user interaction data including click behavior of the plurality of users;
processing the user interaction data and the conversion data via a machine learning model to train the machine learning model, the machine learning model configured to be trained to infer a conversion probability based on new user interaction data;
displaying a first impression on a user interface of the application to a first user;
determining that the first user has selected the displayed first impression;
accessing first user interaction data of a first user indicative of first user click behavior;
processing the first user interaction data via the machine learning model to generate a conversion probability; and
determining whether the selection of the first user of the displayed first impression is a low-quality click based on the conversion probability.

2. The system of claim 1, wherein at least a first subset of the user interaction data is of a first user interaction type that is not visible for the first user subsequent to the first user selecting the displayed first impression.

3. The system of claim 2, wherein at least a second subset of the user interaction data is of a second user interaction type that is visible for the first user subsequent to the first user selecting the displayed first impression, and the second subset of the user interaction data is used to train the machine learning model, and the first user interaction data of the second user interaction type is applied to the machine learning model to generate the conversion probability.

4. The system of claim 3, wherein the second user interaction type includes user behavior prior to a user's selection of an impression, wherein data corresponding to the second user interaction type is used to train the machine learning model and applied to the machine learning model to generate the conversion probability.

5. The system of claim 3, wherein the second user interaction type includes user behavior subsequent to a user's selection of an impression, wherein data corresponding to the second user interaction type is used to train the machine learning model and applied to the machine learning model to generate the conversion probability.

6. The system of claim 1, wherein at least a portion of the user interaction data and the first user interaction data is of a first user interaction type, the first user interaction type including a return to app (RTA) time metric that tracks a duration between a user leaving the the application in response to the user's selection of an impression and the same user's subsequent return to the application, wherein data corresponding to the first user interaction type is used to train the machine learning model and applied to the machine learning model to generate the conversion probability.

7. The system of claim 1, wherein at least a portion of the user interaction data and the first user interaction data is of a first user interaction type, the first user interaction type including a time metric corresponding to a time that an impression is displayed to a user, wherein data corresponding to the first user interaction type is used to train the machine learning model and applied to the machine learning model to generate the conversion probability.

8. The system of claim 1, wherein at least a portion of the user interaction data and the first user interaction data is of a first user interaction type, the first user interaction type including an interaction intensity metric that is associated with an intensely of a user interactions with the application, wherein data corresponding to the first user interaction type is used to train the machine learning model and applied to the machine learning model to generate the conversion probability.

9. The system of claim 8, wherein the interaction intensity metric includes a swipe angle metric indicative of an angle at which a user swipes on the application with his or her finger.

10. The system of claim 8, wherein the interaction intensity metric includes a swipe metric, wherein the impression identifies a swipe as a call-to-action (CTA) for the impression.

11. The system of claim 1, wherein at least a portion of the user interaction data and the first user interaction data is of a first user interaction type, the first user interaction type including a scroll speed metric that is associated with a speed of a user scrolling through content displayed on the application, wherein data corresponding to the first user interaction type is used to train the machine learning model and applied to the machine learning model to generate the conversion probability.

12. The system of claim 1, wherein the first user selection of the displayed first impression is via a swipe, the operations further comprising determining a swipe distance metric that measures the distance a user's finger or cursor travels along a display in order to select the first impression, wherein at least a portion of the user interaction data and the first user interaction data is of a first user interaction type, the first user interaction type including the swipe distance metric that is associated with a speed of a user scrolling through content displayed on the application, wherein data corresponding to the first user interaction type is used to train the machine learning model and applied to the machine learning model to generate the conversion probability.

13. The system of claim 1, wherein at least a portion of the user interaction data and the first user interaction data is of a first user interaction type, the first user interaction type including a click duration metric that is associated with an amount of time a user maintains contact with a user interface when selecting an impression, wherein data corresponding to the first user interaction type is used to train the machine learning model and applied to the machine learning model to generate the conversion probability.

14. The system of claim 1, wherein the operations further comprise:
determining a platform type of the first user, the machine learning model trained to receive different inputs based on differing platform types, processing the first user interaction data comprising inputting data of a certain user interaction type based on the platform type to the machine learning model and the machine learning model trained to generate the conversion probability based on the inputted data of the certain user interaction type.

15. The system of claim 1, wherein the plurality of users are routed to an internal interaction function in response to the plurality of users selecting impressions, wherein the selection of the first impression by the first user results in the first user being routed to a third party system.

16. The system of claim 1, wherein the plurality of users have opted-in to sharing third party data, wherein a selection of impressions by the plurality of users result in the plurality of users being routed to third party systems, wherein the selection of the first impression by the first user results in the first user being routed to a third party system.

17. The system of claim 16, wherein the first user has not opted-in to sharing third party data.

18. The system of claim 16, wherein the user interaction data includes user interaction of the plurality of users of an ad type that is not the same ad type as the first impression selected by the first user, wherein the machine learning model is trained based on user interaction data that is not from the same ad type as the inference performed by the machine learning model to generate the conversion probability for the first user.

19. A method comprising:
accessing user interaction data of a plurality of users on an application and corresponding conversion data, the user interaction data including click behavior of the plurality of users;
processing the user interaction data and the conversion data via a machine learning model to train the machine learning model, the machine learning model configured to be trained to infer a conversion probability based on new user interaction data;
displaying a first impression on a user interface of the application to a first user;
determining that the first user has selected the displayed first impression;
accessing first user interaction data of a first user indicative of first user click behavior;
processing the first user interaction data via the machine learning model to generate a conversion probability; and
determining whether the selection of the first user of the displayed first impression is a low-quality click based on the conversion probability.

20. A non-transitory computer-readable storage medium storing instructions that, when executed by at least one processor, cause the at least one processor to perform operations comprising:
accessing user interaction data of a plurality of users on an application and corresponding conversion data, the user interaction data including click behavior of the plurality of users;
processing the user interaction data and the conversion data via a machine learning model to train the machine learning model, the machine learning model configured to be trained to infer a conversion probability based on new user interaction data;
displaying a first impression on a user interface of the application to a first user;
determining that the first user has selected the displayed first impression;
accessing first user interaction data of a first user indicative of first user click behavior;
processing the first user interaction data via the machine learning model to generate a conversion probability; and
determining whether the selection of the first user of the displayed first impression is a low-quality click based on the conversion probability.
